(19) United States
(12) Patent Application Publication
(10) Pub. No.: US 2013/0322718 A1
(43) Pub. Date: Dec. 5, 2013

(54) METHOD AND APPARATUS FOR MEASUREMENTS OF THE BRAIN PERFUSION IN DYNAMIC CONTRAST-ENHANCED COMPUTED TOMOGRAPHY IMAGES

(71) Applicants: Yi-Hsuan KAO, Taipei City (TW); Michael Mu Huo Teng, Taipei City (TW); Yi-Tzu Kao, Taipei City (TW)

(72) Inventors: Yi-Hsuan KAO, Taipei City (TW); Michael Mu Huo Teng, Taipei City (TW); Yi-Tzu Kao, Taipei City (TW)

(21) Appl. No.: 13/486,974

(22) Filed: Jun. 1, 2012

(51) Int. Cl. G06K 9/00

(52) U.S. Cl. 382/131

(57) ABSTRACT

The present invention discloses a method and apparatus for measuring AIF and VOF on brain perfusion CT images. The AIF and VOF are used to calculate hemodynamic parameters. In this invention, bone voxels and neighboring voxels are removed first from the perfusion images and thus only brain voxels are included in the AIF and VOF measurement procedures; moreover, the selection criteria, such as large area under the concentration-time curve, early arrival of contrast agents, and narrow effective width, are used to select appropriate arterial and venous voxels for the AIF and VOF measurements.

### BACKGROUND OF THE INVENTION

1. Field of the Invention

The present invention relates generally to a method and apparatus for brain perfusion measuring technique, and more particularly, to a method and apparatus for measuring arterial input function (AIF) and venous output function (VOF) on brain perfusion computed tomography (CT) images. The AIF and VOF are used to calculate hemodynamic parameters.

2. Background

Brain perfusion CT images provide information on the local perfusion of brain tissue for patients with cerebral vascular diseases, such as acute ischemic stroke and proximal arterial stenosis. Using this technique, the passage of contrast agent molecules through the brain is recorded by acquiring dynamic images. According to the indicator dilution theory, the cerebral blood volume (CBV) for a tissue voxel is calculated as the ratio of the areas under the concentration-time curve (AUC) between a tissue voxel and a reference voxel containing 100% blood. Typically, a voxel at the posterior end of the superior sagittal sinus is used as the reference voxel, and its concentration-time curve is called the VOF.

For the deconvolution calculation of cerebral blood flow (CBF), an additional AIF is needed. The AIF is the concentration-time curve of an arterial voxel containing 100% blood. Because arterial vessels are smaller than the voxel size of CT images, the measured concentration-time curve at an arterial voxel, Cartery(t), is reduced by a factor equal to the partial volume (PV) of blood in the voxel. The AIF can be calculated from Cartery(t) using the VOF as a correction reference. Typically, a voxel at either the anterior cerebral artery or the middle cerebral artery is selected for measuring Cartery(t). The additional manual selection process requires an experienced operator to identify the veins and arteries on brain perfusion CT images for measuring the VOF and AIF. A review on these postprocessing techniques can be found in Konstas A A et al. Theoretical basis and technical implementations of CT perfusion in acute ischemic stroke, part 1: theoretic basis. AJNR Am J Neuroradiol 2009; 30:662-668.

U.S. Pat. No. 6,512,807, issued to Pohlman, et al. entitled “Low signal correction for perfusion measurements” discloses that a CT scanner for obtaining a medical diagnostic image of a subject includes a stationary gantry, and a rotating gantryrotatably supported on the stationary gantry for rotation about the subject. In a perfusion study 130 time-density curves of voxels of an imaging region are computed. In a low signal identification step, all voxels with low signal are identified. In a clustering step, low signal voxels are clustered together. In a representative determination step representative time-density curves are computed. In a functional measurement step, measurements are calculated from the combined and uncombined time-density values. In an assigning step, each low signal voxel is assigned the values determined for its group. In a combining step the results of the low and normal signal voxels are combined to produce a single functional perfusion image.

U.S. Pat. No. 6,745,066, issued to Lin, et al. entitled “Measurements with CT perfusion” discloses that a CT scanner for obtaining a medical diagnostic image of a subject includes a stationary gantry, and a rotating gantry. The detected radiation is reconstructed and divided into sub-portions, which sub-portions are aligned by a registration processor. The registered images are stored in a high resolution memory and a maximum artery enhancement value is calculated from the high resolution images. A resolution reducer reduces the resolution of the high resolution images. Time-density curves are found for the voxels of the images, which time-density curves are truncated to eliminate unwanted data, and analyzed to determine characteristic values. A perfusion calculator calculates perfusion by using the maximum artery enhancement value and the characteristic values. A diagnostician can view any one of a low resolution image, a high resolution image, and a perfusion image on a video monitor.

U.S. Pat. No. 7,912,269, issued to Ikeda et al. entitled “Medical image processing apparatus and method of processing medical image” discloses that according to a medical image processing apparatus, a data of a region of the blood vessel is removed from respectives of a plurality of sheets of original image data collected by scanning a subject injected with a contrast medium by a medical modality, thereafter, a pixel value of the region of the blood vessel is substituted for by pixel values of a plurality of pixels present at a surrounding of the region, the plurality of sheets of original image data including the substituted region of the blood vessel are subjected to a preprocessing including a noise removing processing and a pixel bundling processing, and circulation dynamic state information of perfusion of a substantial portion is analyzed from the plurality of sheets of original image data subjected to the preprocessing.

Moreover, paper titled as “Reproducibility of postprocessing of quantitative CT perfusion maps.” by Pina C, et al. in AJR 2007; 188:213-218; and paper titled as “Automated versus manual post-processing of perfusion-CT data in patients with acute cerebral ischemia: influence on interobserver variability” by Bruno P. et at. in Neuroradiology 2009; 51:445-451. are also used as references.

As a result, postprocessing of the brain perfusion CT images cannot be fully automatic in clinical practice. Automatic techniques on brain perfusion CT images for measuring the VOF and AIF have been developed. However, the failure rate of the typical automatic techniques on brain perfusion CT images of prior arts varied between 10% and 55%. Two factors contribute to the failure of automatic selection techniques. First, bone has a very high signal on CT images, and the motion artifact of bone causes unexpected false peaks in the signal-time curves at neighboring voxels. Second, usually only one venous voxel and one arterial voxel are used for the VOF and AIF measurements, which are easily affected by random noise. As a result, motion artifact of bone and random noise cause erroneous VOF and AIF measurements with the automatic techniques.

Therefore, it is needed to provide a method and apparatus to overcome the above described problems. In this invention, the VOF and AIF measurements based on brain perfusion CT images are disclosed. The technique can be implemented as a software or a hardware, used in imaging systems, for automatic calculation of CBV and CBF.

### BRIEF SUMMARY OF THE INVENTION

It is an objective of the present invention to provide a method for measurement of the brain perfusion in dynamic contrast-enhanced CT images.

It is another objective of the present invention to provide a medical image processing apparatus for measurement of the brain perfusion in dynamic contrast-enhanced CT images.

To achieve the above objective, the present invention provides a method for measurement of the brain perfusion in dynamic contrast-enhanced CT images, comprising the steps of: (a) acquiring a series of brain perfusion CT images from a subject's brain wherein the CT images comprises a plurality of bone voxels and a plurality of non-bone voxels, the subject being administered with a contrast agent; (b) forming a time course CT image data set with the acquired brain perfusion CT images, the time course CT image data set providing a plurality of time course voxel studies which indicate the magnitude of CT signals produced during the study at voxels throughout the tissues; (c) removing the plurality of bone voxels in the brain perfusion CT images; and (d) producing at least a VOF by selecting M voxels from the plurality of time course voxel studies of time course CT image data set, M is a positive integer.

According to one feature of the method of the invention, the method further comprises the step of: (e) producing at least a AIF based on the produced VOF produced in step (d) and the plurality of time course voxel studies.

To achieve another objective, the present invention provides an apparatus for measurement of the brain perfusion in dynamic contrast-enhanced CT images, mainly comprising a CT device and a computer. The CT device is used for performing a series of brain perfusion CT images from a subject's brain wherein the CT images comprises a plurality of bone voxels and a plurality of non-bone voxels, the subject being administered with a contrast agent. The computer is electrically connected to the CT device and is used for processing the series of brain perfusion CT images. The computer has a computer program inside the computer for measurement of the brain perfusion in dynamic contrast-enhanced CT images. The computer program comprising a method comprising the steps of: (a) acquiring a series of brain perfusion CT images from a subject's brain wherein the CT images comprises a plurality of bone voxels and a plurality of non-bone voxels, the subject being administered with a contrast agent; (b) forming a time course CT image data set with the acquired brain perfusion CT images, the time course CT image data set providing a plurality of time course voxel studies which indicate the magnitude of CT signals produced during the study at voxels throughout the tissues; (c) removing the plurality of bone voxels in the brain perfusion CT images; and (d) producing at least a VOF by selecting M voxels from the plurality of time course voxel studies of time course CT image data set, M is a positive integer.

According to one feature of the apparatus of the invention, the method further comprises the step of: (e) producing at least a AIF based on the produced VOF produced in step (d) and the plurality of time course voxel studies.

The disclosed technique can be easily integrated into software or hardware for the automatic calculation of parametric images, such as CBV and CBF, from brain perfusion CT images.

These and many other advantages and features of the present invention will be readily apparent to those skilled in the art from the following drawings and detailed descriptions.

### BRIEF DESCRIPTION OF THE DRAWINGS

All the objectives, advantages, and novel features of the invention will become more apparent from the following detailed description when taken in conjunction with the accompanying drawings.

FIG. 1 is a general flowchart for measurement of AIF and VOF on brain perfusion CT images.

FIG. 2 (a) a perfusion image; (b) bone mask; (c) bone mask with 7×7 binary dilation; (d) brain mask; and (e) brain-only perfusion image.

FIG. 3 is a schematic diagram of an imaging system that can incorporate the new methods embodied in software.

FIG. 4 shows (a) the automatically selected arterial voxels marked using crosses, (b) the five venous voxels marked using crosses, (c) the automatically measured C_{artery}(t) and the automatically measured VOF(t) and (d) plots the curve-fitted AIF and VOF. In FIG. 4(c), the automatically measured Cartery(t) is plotted using a solid line and the automatically measured VOF(t) is plotted using a dash-dot line. The curve-fitted AIF (solid line) and VOF (dash-dot line) are plotted in FIG. 4(d).

### DETAILED DESCRIPTION OF THE INVENTION

Although the invention has been explained in relation to several preferred embodiments, the accompanying drawings and the following detailed descriptions are the preferred embodiment of the present invention. It is to be understood that the following disclosed descriptions will be examples of present invention, and will not limit the present invention into the drawings and the special embodiment.

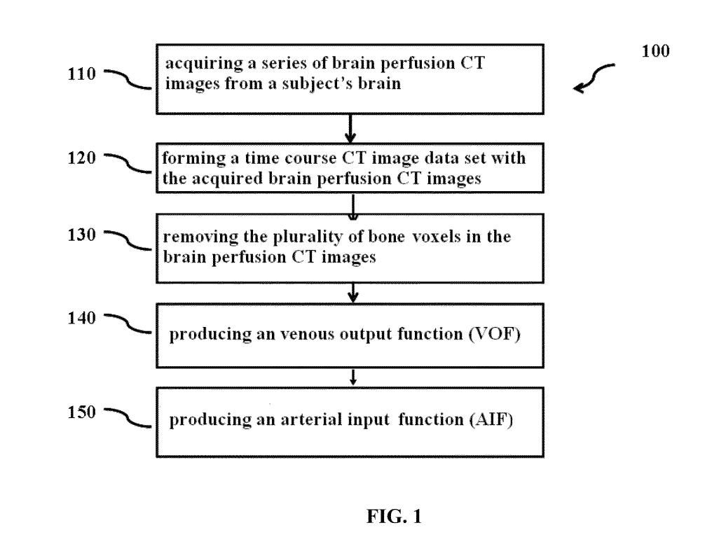

FIG. 1 is a general flowchart for measurement of AIF and VOF on brain perfusion CT images. The method comprises the steps of:

Step (110) acquiring a series of brain perfusion CT images from a subject's brain wherein the CT images comprises a plurality of bone voxels and a plurality of non-bone voxels, the subject being administered with a contrast agent;

Step (120) forming a time course CT image data set with the acquired brain perfusion CT images, the time course CT image data set providing a plurality of time course voxel studies which indicate the magnitude of CT signals produced during the study;

Step (130): removing the plurality of bone voxels in the brain perfusion CT images; and

Step (140): producing at least an VOF by selecting M voxels from the plurality of time course voxel studies of time course CT image data set, M is a positive integer.

It is noted that step (150) is followed after the step (140), but is not needed in this method. The step (150) is to produce at least a AIF based on the produced VOF produced in step (140) and the plurality of time course voxel studies.

It is noted that after performing the method of the present invention, a hemodynamic parameter for each voxel can be calculated using the plurality of time course voxel studies and the AIF produced in step 150). In which, the hemodynamic parameter is selected from the group of cerebral blood flow (CBF) and cerebral blood volume (CBV).

In step (110), the method is to acquire a series of brain perfusion CT images from a subject's brain wherein the CT images comprises a plurality of bone voxels and a plurality of non-bone voxels.

For example, the brain perfusion CT images are routinely acquired from patients with some cerebral vascular diseases using a clinical CT scanner. The clinical CT scanner is, but not limited to, Brilliance 40, Philips Medical Systems, Cleveland, Ohio. The imaging protocol was as follows: 80 kVp, 150 mAs, field of view=25×25 cm², and image matrix=512×512. The slice thickness was 5 mm with no gap, and 8 slices were acquired with 40 dynamic images for each slice. The temporal resolution was one second. A bolus of 40 mL of iohexol with a concentration of 350 mg/mL of iodine (Omnipaque, GE Healthcare, Ireland) followed by 40 mL of normal saline was administered via an antecubital vein with a flow rate of 4 mL/s using a power injector (Ulrich Medizintechnik, Ulrich GmbH & Co. KG, Ulm, Germany).

In step (120), the method is to form a time course CT image data set with the acquired brain perfusion CT images, the time course CT image data set providing a plurality of time course voxel studies which indicate the magnitude of CT signals produced during the study at voxels throughout the tissues.

The time course CT image data set is described as follows:

The concentration of contrast agents for a voxel on brain perfusion CT images is related to the signal increase expressed as:

C(t)=k₁[S(t)−S₀] [1]

where k₁ is a constant that converts the Hounsfield units to concentration, S(t) is the signal at time t, and S₀ is the baseline signal before the arrival of the contrast agents. Because k₁ is a constant, and it is canceled out in the CBV and CBF calculation, it is set k₁=1 to simplify the calculation.

According to the indicator dilution theory, the CBV for a voxel is the ratio of the AUCs between a tissue voxel, Cₜᵢₛₛᵤₑ(t), and a voxel containing 100% blood, C_{blood}(t), during the first pass of the contrast agent as described by:

$$CBV = \frac{{k}_{H}}{ρ} \frac{{\int }_{first pass} {C}_{tissue} ( t ) d t}{{\int }_{first pass} {C}_{blood} ( t ) d t} \qquad [ 2 ]$$

where k_{H} is a correction factor that accounts for the difference in hematocrit between the vessel and the capillaries, and ρ is the density of the brain tissue. The concentration-time curve can be fitted to a gamma-variate function to extract the first pass of contrast agents. The mathematical form for a gamma-variate function is described by:

C_{Gamma}(t)=k₂(t−t_{G})^{α}e^{-(t-t}^{_{G}}^{)/β} [3]

where k₂ is a constant, t_{G} is the contrast agent arrival time of the fitted gamma-variate function, and α and β are related to the wash-in and wash-out of contrast agents, respectively. The AUC for the fitted curve is described by:

$${AUC}_{fit} = {\int }_{first pass} {C}_{Gamma} ( t ) d t = {k}_{2} {β}^{α + 1} Γ ( α + 1 ) , \qquad [ 4 ]$$

the peak concentration is:

C_{Gamma}(t)|ₘₐₓ=k₂(αβ)e^{-α}, [5]

and the effective width (EW) of the curve is the AUC divided by the peak concentration described by:

EW=α⁻¹β^{α}e^{α}Γ(α+1) [6]

Because AIF(t) and VOF(t) are both assumed to be measured from voxels containing 100% blood, their CBV are the same, and this relationship is expressed as:

$${\int }_{first pass} AIF ( t ) d t = {\int }_{first pass} VOF ( t ) d t \qquad [ 7 ]$$

However, arterial vessels are smaller than the voxel size on CT images, and the concentration-time curve measured at an arterial voxel, C_{artery}(t), is affected by the PV of the blood in the arterial voxel, described by:

C_{artery}(t)=PV·AIF(t)+(1−PV)·Cₜᵢₛₛᵤₑ(t). [8]

where Cₜᵢₛₛᵤₑ(t) is the concentration-time curve for a tissue voxel. Because AIF(t) is much larger than Cₜᵢₛₛᵤₑ(t), assuming that PV is between 0.2 and 1.0 for arterial voxels, C_{artery}(t) can be approximated as:

C_{artery}(t)=PV·AIF(t) [9]

As a result, the PV value for an arterial voxel can be calculated as:

$$PV = \frac{{C}_{artery} ( t )}{AIF ( t )} = \frac{{\int }_{first pass} {C}_{artery} ( t ) d t}{{\int }_{first pass} AIF ( t ) d t} = \frac{{\int }_{first pass} {C}_{artery} ( t ) d t}{{\int }_{first pass} VOF ( t ) d t} \qquad [ 10 ]$$

and the AIF(t) can be calculated as:

$$AIF ( t ) = \frac{{C}_{artery} ( t )}{PV} = {C}_{artery} ( t ) \frac{{\int }_{first pass} VOF ( t ) d t}{{\int }_{first pass} {C}_{artery} ( t ) d t} \qquad [ 11 ]$$

In step (130), in order to remove the plurality of bone voxels in the brain perfusion CT images, the step (130) comprises the steps of:

Step (131): registering the series of brain perfusion CT images by using an internal structure bone voxel signals; and

Step (132): generating a bone-mask image for the registered brain perfusion CT images by applying a threshold value of P Hounsfield units, wherein voxels with a signal value of larger than P Hounsfield units are identified as bone voxels, and voxels with a value of less than P Hounsfield units are identified as non-bone voxels, P is a positive integer.

It is noted that the step (130) further comprises the steps of:

Step (133): extending a bone area of the bone-mask images by applying a Q×Q binary dilation kernel to remove the neighboring voxels with partial volume mixing with bone that might have motion artifacts on the perfusion images, wherein Q is a positive integer.

In an embodiment, the 40 perfusion images were registered to the first perfusion image using the internal structure and a three-dimensional principle-axis-transformation technique in step (131). The internal structure could be but not limited to bone voxel signals, bone surface and brain surface. In the embodiment, the internal structure are bone voxel signals. The bone voxel had a signal higher than 800 Hounsfield units, and this value was much higher than the signals of artery, vein, and brain tissues. Voxels with a value of less than 800 Hounsfield units were identified as non-bone voxels, and their signals were adjusted to zero. For each time point, the bone voxel signals on the eight-slice images were treated as a three-dimensional probability density function. The mean and covariance matrices of the 40 probability density functions were calculated from the 40 perfusion images. A principle component analysis was used to calculate the eigenvalues and eigenvectors for each covariance matrix. Translational motion, rotational motion, and scaling factors were corrected by using the mean matrices, eigenvectors and eigenvalues of the covariance matrices, respectively.

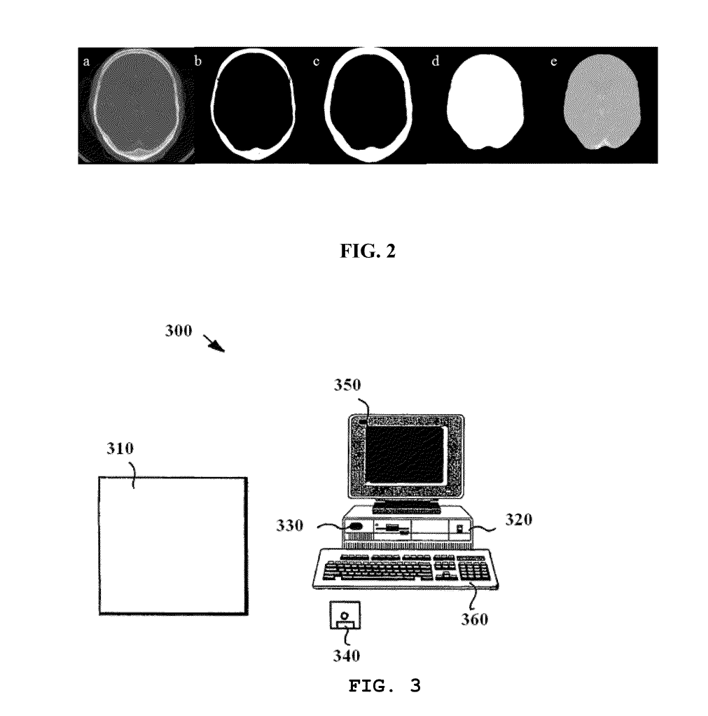

After performing the image registration, bone-mask images in step (132) were generated for the 40 perfusion images by applying a threshold of 800 Hounsfield units to the registered perfusion images. Namely, P is 800 in the embodiment. Preferably, P is from 500 to 1100. A 7×7 binary dilation kernel was applied to the bone-mask images to further extend the bone area, in step (133). Namely, Q is 7 in the embodiment. Preferably, Q is from 1 to 13. The purpose of the dilation process was to remove voxels with partial volume mixing with bone that might have motion artifacts on the perfusion images. Voxels that were inside the bone area were segmented as a brain mask. The signal intensities for voxels that were not identified as brain voxels were set to zero. An isotropic diffusion filter was applied to the brain-voxel perfusion images to improve the signal-to-noise ratio of the perfusion images, while also preserving the edge between the different tissue types. The registered, filtered, brain-only perfusion images were used in the AIF and VOF measurements. FIG. 2 shows the picture described in step (130). (a) a perfusion image; (b) bone mask; (c) bone mask with 7×7 binary dilation; (d) brain mask; and (e) brain-only perfusion image.

In step (140), in order to ally produce an VOF by selecting M voxels from the plurality of time course voxel studies of time course CT image data set, M is a positive integer, the step (140) further comprises the step of:

Step (141): simplifying a summation of concentration-time curve of the plurality of time course voxel studies to estimate an area under the concentration-time curve (AUCₛᵤₘ);

Step (142): fitting the AUCₛᵤₘ values for the brain voxels with the largest AUCₛᵤₘ arranged in descending order to a gamma-variate function using a trust-region-reflective algorithm to calculate a first plurality of correlation coefficients;

Step (143): selecting and averaging M voxels from the plurality of time course voxel studies of time course CT image data set with the largest AUCₛᵤₘ and the first plurality of correlation coefficients, M is a positive integer, to be an in-plane VOF; and

Step (144): producing the VOF by fitting a plurality of in-plane VOF curves the gamma-variate function to obtain a AUC_{fit}, wherein the VOF is the selected from the a plurality of in-plane VOF with the largest AUC_{fit}.

In an embodiment, because it is time consuming to calculate the AUC_{fit} using a curve fitting to a gamma-variate function for all brain voxels, a simple summation of the concentration-time curve in step (141) is used to estimate the AUC:

$${AUC}_{sum} = {\sum }_{t = 1}^{40} C ( t ) \qquad [ 12 ]$$

On the posterior half of each slice, the AUCₛᵤₘ values for the brain voxels were arranged in descending order. Starting from the voxel with the largest AUCₛᵤₘ, the concentration-time curves were fitted to a gamma-variate function Paper titled to Coleman T F, et al. “On the convergence of interior-reflective Newton methods for nonlinear minimization subject to bounds” in Math Prog 1994; 67:189-224 and paper entitled to Coleman T F et al. “An interior trust region approach for nonlinear minimization subject to bounds” in SIAM J. Optim 1996; 6:418-445. are used to show the trust-region-reflective algorithm.

The correlation coefficients between the measured concentration-time curves and the fitted curves in step (142) were calculated. The five voxels with the largest AUCₛᵤₘ values and the correlation coefficients those in step (143) were larger than 0.5, preferably 0.8, were selected as the venous voxels for the VOF measurement. Namely, M is 5 in the embodiment. Preferably, M is from 2 to 8. The averaged concentration-time curve for these five venous voxels was used as an in-plane VOF in each slice. The eight in-plane VOF curves were fitted to a gamma-variate function in this embodiment. The AUC_{fit}'s for the eight fitted VOFs were calculated using Eq. [4]. The fitted VOF with the largest AUC_{fit} was used as a global VOF for the following AIF calculation, in step (144).

In step (150), it is noted that the plurality of time course voxel studies comprises a partial volume (PV) of the blood in a voxel, a contrast agent arrival time (Ta), and an effective width (EW) of the concentration-time curve are used to identify a plurality of arterial voxels in the brain perfusion CT images.

Thus, in the step (150), in order to ally produce an AIF based on the produced VOF produced in step (140) and the plurality of time course voxel studies. The step (15) further comprises the steps of:

Step (151) identifying a plurality of voxels with AUCsum values as vessel voxels;

Step (152) sorting the vessel voxels from the smallest Ta value to the largest Ta value to obtain the first R vessel voxels being chosen for measuring a concentration-time curve measured at the arterial voxel, Cartery(t), wherein Ta is the contrast agent arrival time (Ta) and R is a positive integer;

Step (153): averaging the concentration-time curves for the N arterial voxels with the smallest effective width (EW) values to obtain Cartery(t), wherein N is a positive integer.

A global AIF was measured from the lowest slice of the perfusion images. Three criteria were used to select five arterial voxels for the measurement of C_{artery}(t). The first criterion was the PV of blood in a voxel. Voxels with AUCₛᵤₘ values larger than 20% of the AUC_{fit} of the global VOF were identified as vessel voxels, in step (151). The second criterion was the bolus arrival time. For each vessel voxel, every 6 consecutive temporal data points along the concentration-time curve, C(t), were fitted to a straight line described by C(t)=mt+b using a least-square-error technique. The largest m value was recorded to represent the uptake slope of the contrast agent at that vessel voxel. The time at which the straight line with the largest slope intercepted the horizontal axis, e.g., C(t)=0, was calculated as Tₐ=−(b/m) using the largest m, and it was used as an estimate of the contrast arrival time. The vessel voxels were sorted from the smallest Tₐ value to the largest Tₐ value. The first 300 vessel voxels were chosen as the candidates for measuring C_{artery}(t), in step (152).

The third criterion was the narrowness of the curve. The concentration-time curves of the selected 300 vessel voxels were fitted to a gamma-variate function. Namely, R is 300 in the embodiment. Preferably, R is from 10 to 590. The correlation coefficients between the measured and fitted concentration-time curves were calculated. Voxels with a coefficient lower than 0.9 were excluded from the selection process. After performing the fitting, the EW values calculated using Eq. [6] for the selected voxels were sorted from smallest to largest. The averaged concentration-time curve for the five arterial voxels with the smallest EW values was used as C_{artery}(t). Namely, N is 5 in the embodiment. Preferably, N is from 2 to 8. The C_{artery}(t) curve was fitted to a gamma-variate function to extract the first pass. The AIF(t) was calculated from the fitted C_{artery}(t) using Eq. [11] and the global VOF(t), in step (153).

Implementation

In some embodiments, the steps described above are implemented in computer programs using standard programming techniques or directly in an apparatus. Therefore, the apparatus 300 for measurement of AIF and VOF on brain perfusion CT images, mainly comprising: a CT device 310 and a computer 320. The CT device 310 is used for performing a series of brain perfusion CT images from a subject's brain wherein the CT images comprises a plurality of bone voxels and a plurality of non-bone voxels, the subject being administered with a contrast agent. The computer 320 is electrically connected to the CT device 310 and used for processing the series of brain perfusion CT images, the computer having a computer program inside the computer for measurement of AIF and VOF on the series of brain perfusion CT images. A computer program is set inside the computer 320 to control the CT device 310 and process the processing the series of brain perfusion CT images. The computer program comprises a method as described above. The method comprises the steps of: (a) acquiring a series of brain perfusion CT images from a subject's brain wherein the CT images comprises a plurality of bone voxels and a plurality of non-bone voxels, the subject being administered with a contrast agent; (b) forming a time course CT image data set with the acquired brain perfusion CT images, the time course CT image data set providing a plurality of time course voxel studies which indicate the magnitude of CT signals produced during the study at voxels throughout the tissues; (c) removing the plurality of bone voxels in the brain perfusion CT images; and (d) producing at least an VOF by selecting M voxels from the plurality of time course voxel studies of time course CT image data set, M is a positive integer. It is noted that the method in the computer program further comprises the step of (e) producing at least an AIF based on the produced VOF produced in step (d) and the plurality of time course voxel studies.

Such an apparatus or programs are designed to execute on programmable computers each comprising an electronic processor, a data storage system (including memory and/or storage elements). In some embodiments, the program code is applied to control the acquisition of the image data, such as CT data, using a pulse sequence stored in the software. In other embodiments, the code is applied directly to acquired data (e.g., CT data from the imager) to perform the functions described herein and generate output information (e.g. CBF or CBV), which is applied to one or more output devices. In yet other embodiments, the program code is applied to acquisition of the data by controlling a CT imager and to the subsequent analysis described herein. Each such computer program can be implemented in a high-level procedural or object-oriented programming language, or an assembly or machine language. Furthermore, the language can be a compiled or interpreted language. Each such computer program can be stored on a computer readable (machine-readable) storage medium (e.g., CD ROM or magnetic diskette) that when read by a computer can cause the processor in the computer to perform the analysis described herein.

The software using the disclosed method of the present invention can be manufactured and/or sold, e.g., by medical imaging system manufacturers either as part of the original software supplied to the CT device 310 or other imaging device, or as a later add-on “upgrade” to existing imaging devices. The software can also be made and/or sold by independent software manufacturers directly to users of such CT device 310 or other imaging devices.

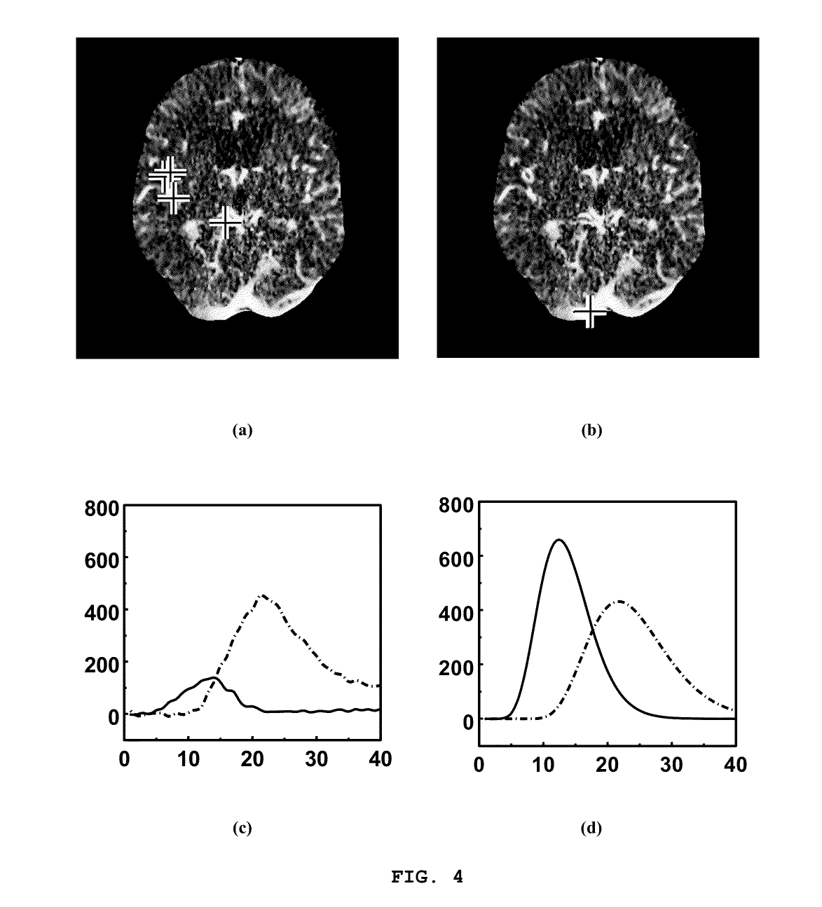

In this invention, the disclosed method can be implemented as a software or a hardware, used in imaging systems. For example, as shown in FIG. 3, it is a schematic diagram of an imaging system that can incorporate the new methods embodied in software. The imaging system 300 can include an CT device 310 and a processor 320, such as a person computer or microprocessor. A memory 330 is coupled to the processor 320 that contains a software using the disclosed method of the present invention, or reads the software from a computer-readable storage device 340. The memory 330 contains the new software of the present invention. The apparatus 300 can also include an output device 350 for displaying the blood perfusion parameter, such as a monitor, e.g., CRT, or printer. The apparatus can also include an input device 360, such as a keyboard or mouse, for providing data or instructions to the system.

FIG. 4 shows the automatically selected arterial voxels marked using crosses in (a) and the venous voxels marked using crosses in (b). In (c), the automatically measured Cartery(t) and the automatically measured VOF(t) are displayed. (d) plots the curve-fitted AIF and VOF. In FIG. 4(c), the automatically measured Cartery(t) is plotted using a solid line and the automatically measured VOF(t) is plotted using a dash-dot line. The curve-fitted AIF (solid line) and VOF (dash-dot line) are plotted in FIG. 4(d).

Function.

The measurement of AIF and VOF is essential for the processing of brain perfusion CT images. Automatic measurement techniques of the prior art are inadequate because they are prone to motion artifact and random noise. In this invention, a principle axis transformation technique is disclosed to improve the registration of perfusion images. The bone voxels and the neighboring voxels are removed first from the perfusion images and only the brain voxels were used in the measurement procedure. The registration and removal process reduces the probability that a slight misalignment of the bone voxels caused by motion artifacts may produce unexpected high signal variations in the concentration-time curves.

In the proposed technique of the present invention, five venous voxels and five arterial voxels were used for the measurement of VOF and AIF, respectively. The effect of random noise was reduced compared with the use of only one arterial voxel and one venous voxel. The number of voxels used in the measurements can easily be changed.

In the AIF measurements, criteria such as large AUC, high peak concentration, and short time to peak of the concentration-time curve were commonly used for determining the appropriate arterial voxels in prior studies. In this invention, the PV of blood in a voxel, the contrast agent arrival time, and the EW of the concentration-time curve to identify possible arterial voxels.

The functions and the advantages of the present invention have been shown. Although the invention has been explained in relation to several preferred embodiments, the accompanying drawings and the following detailed descriptions are the preferred embodiment of the present invention. It is to be understood that the following disclosed descriptions will be examples of present invention, and will not limit the present invention into the drawings and the special embodiment. Moreover, it is to be understood that many other possible modifications and variations can be made by those skilled in the art without departing from the spirit and scope of the invention as hereinafter claimed.

What is claimed is:

1. A method for measurement of the brain perfusion in dynamic contrast-enhanced computed tomography (CT) images, comprising the steps of:
(a) acquiring a series of brain perfusion CT images from a subject's brain wherein the CT images comprises a plurality of bone voxels and a plurality of non-bone voxels, the subject being administered with a contrast agent;
(b) forming a time course CT image data set with the acquired brain perfusion CT images, the time course CT image data set providing a plurality of time course voxel studies which indicate the magnitude of CT signals produced during the study;
(c) removing the plurality of bone voxels in the brain perfusion CT images; and
(d) producing at least an venous output function (VOF) by selecting M voxels from the plurality of time course voxel studies of time course CT image data set, M is a positive integer.

2. The method as claimed in claim 1, the method further comprising the step of:
(e) producing at least an arterial input function (AIF) based on the produced VOF produced in step (d) and the plurality of time course voxel studies.

3. The method as claimed in claim 2, wherein after performing the method, a hemodynamic parameter for each voxel is calculated using the plurality of time course voxel studies and the AIF produced in step e).

4. The method as claimed in claim 3, wherein the hemodynamic parameter is selected from the group of cerebral blood flow (CBF) and cerebral blood volume (CBV).

5. The method as claimed in claim 1, wherein the step (c) comprises the steps of:
(c-1) registering the series of brain perfusion CT images by using an internal structure; and
(c-2) generating a bone-mask image for the registered brain perfusion CT images by applying a threshold value of P Hounsfield units, wherein voxels with a signal value of larger than P Hounsfield units are identified as bone voxels, and voxels with a value of less than P Hounsfield units are identified as non-bone voxels, P is a positive integer.

6. The method as claimed in claim 5, wherein the step (c) further comprises the steps of:
(c-3) extending a bone area of the bone-mask images by applying a Q×Q binary dilation kernel, wherein Q is a positive integer.

7. The method as claimed in claim 1, wherein the step (d) further comprises the step of:
(d-1) simplifying a summation of concentration-time curve of the plurality of time course voxel studies to estimate an area under the concentration-time curve (AUCₛᵤₘ);
(d-2) fitting the concentration-time curve for the voxels with the largest AUCₛᵤₘ arranged in descending order to a gamma-variate function to calculate a first plurality of correlation coefficients;
(d-3) selecting and averaging M voxels from the plurality of time course voxel studies of time course CT image data set with the largest AUCₛᵤₘ and the first plurality of correlation coefficients, M is a positive integer, to be an in-plane VOF; and
(d-4) producing the VOF by fitting a plurality of in-plane VOF curves the gamma-variate function to obtain a AUC_{fit}, wherein the VOF is the selected from the plurality of in-plane VOF with the largest AUC_{fit}.

8. The method as claimed in claim 1, wherein in the step (e), the plurality of time course voxel studies comprise a partial volume (PV) of the blood in a voxel, a contrast agent arrival time (Ta), and an effective width (EW) of the concentration-time curve are used to identify a plurality of arterial voxels in the brain perfusion CT images.

9. The method as claimed in claim 8, wherein the step (e) further comprises the steps of:
(e-1) identifying a plurality of voxels with AUCₛᵤₘ values as vessel voxels;
(e-2) sorting the vessel voxels from the smallest Ta value to the largest Ta value to obtain the first R vessel voxels being chosen for measuring a concentration-time curve measured at the arterial voxel, Cartery(t), wherein Ta is the contrast agent arrival time and R is a positive integer; and
(e-3) averaging the concentration-time curves for the N arterial voxels with the smallest EW values to obtain Cartery(t), wherein N is a positive integer.

10. An apparatus for measurement of the brain perfusion in dynamic contrast-enhanced computed tomography (CT) images, mainly comprising:
a CT device, used for performing a series of brain perfusion CT images from a subject's brain wherein the CT images comprises a plurality of bone voxels and a plurality of non-bone voxels, the subject being administered with a contrast agent;
a computer, electrically connected to the CT device, used for processing the series of brain perfusion CT images, the computer having a computer program inside the computer for measurement of the brain perfusion in dynamic contrast-enhanced CT images, the computer program comprising a method comprising the steps of
(a) acquiring a series of brain perfusion CT images from a subject's brain wherein the CT images comprises a plurality of bone voxels and a plurality of non-bone voxels, the subject being administered with a contrast agent;
(b) forming a time course CT image data set with the acquired brain perfusion CT images, the time course CT image data set providing a plurality of time course voxel studies which indicate the magnitude of CT signals produced during the study;
(c) removing the plurality of bone voxels in the brain perfusion CT images; and
(d) producing at least an VOF by selecting M voxels from the plurality of time course voxel studies of time course CT image data set, M is a positive integer.

11. The apparatus as claimed in claim 10, wherein the method further comprises the step of:
(e) producing at least an AIF based on the produced VOF produced in step (d) and the plurality of time course voxel studies.

12. The apparatus as claimed in claim 10, wherein after performing the method, a hemodynamic parameter for each voxel is calculated using the plurality of time course voxel studies and the AIF produced in step e).

13. The apparatus as claimed in claim 11, wherein the hemodynamic parameter is selected from the group of cerebral blood flow (CBF) and cerebral blood volume (CBV).

14. The apparatus as claimed in claim 10, wherein the step (c) comprises the steps of:
(c-1) registering the series of brain perfusion CT images by using an internal structure; and
(c-2) generating a bone-mask image for the registered brain perfusion CT images by applying a threshold value of P Hounsfield units, wherein voxels with a signal value of larger than P Hounsfield units are identified as bone voxels, and voxels with a value of less than P Hounsfield units are identified as non-bone voxels, P is a positive integer.

15. The apparatus as claimed in claim 14, wherein the step (c) further comprises the steps of:
(c-3) extending a bone area of the bone-mask images by applying a Q×Q binary dilation kernel, wherein Q is a positive integer.

16. The apparatus as claimed in claim 10, wherein the step (d) further comprises the step of:
(d-1) simplifying a summation of concentration-time curve of the plurality of time course voxel studies to estimate an area under the concentration-time curve (AUCₛᵤₘ);
(d-2) fitting the concentration-time curve for the voxels with the largest AUCₛᵤₘ arranged in descending order to a gamma-variate function to calculate a first plurality of correlation coefficients;
(d-3) selecting and averaging M voxels from the plurality of time course voxel studies of time course CT image data set with the largest AUCₛᵤₘ and the first plurality of correlation coefficients, M is a positive integer, to be an in-plane VOF; and
(d-4) producing the VOF by fitting a plurality of in-plane VOF curves the gamma-variate function to obtain a AUC_{fit}, wherein the VOF is the selected from the plurality of in-plane VOF with the largest AUC_{fit}.

17. The apparatus as claimed in claim 10, wherein in the step (e), the plurality of time course voxel studies comprise a partial volume (PV) of the blood in a voxel, a contrast agent arrival time (Ta), and an effective width (EW) of the concentration-time curve are used to identify a plurality of arterial voxels in the brain perfusion CT images.

18. The apparatus as claimed in claim 17, wherein the step (e) further comprises the steps of:
(e-1) identifying a plurality of voxels with AUCₛᵤₘ values as vessel voxels;
(e-2) sorting the vessel voxels from the smallest Ta value to the largest Ta value to obtain the first R vessel voxels being chosen for measuring a concentration-time curve measured at the arterial voxel, Cartery(t), wherein Ta is the contrast agent arrival time and R is a positive integer; and
(e-3) averaging the concentration-time curves for the N arterial voxels with the smallest EW values to obtain Cartery(t), wherein N is a positive integer.
